(19) United States
(12) Patent Application Publication
(10) Pub. No.: US 2007/0084767 A1
(43) Pub. Date: Apr. 19, 2007

(54) Marine water conversion

(76) Inventor: Gerald L. Barber, Greenville, SC (US)

Correspondence Address: John B. Hardaway, III;NEXSEN PRUET, LLC, P.O. Box 10107, Greenville, SC, 29603, US

(21) Appl. No.: 11/253,247

(22) Filed: Oct. 18, 2005

(51) Int. Cl. C02F 1/00; E02B 15/00

(52) U.S. Cl. 210/143; 210/120; 210/121; 210/170.05; 210/170.11; 114/343; 440/1; 440/2; 405/195.1; 405/80

(57) ABSTRACT

A marine water conversion apparatus capable of transferring ocean surface water several hundred feet below the surface to cause sufficient cooler water to rise to the surface to prevent formation of or to moderate hurricanes. The apparatus is remotely controlled and includes a propulsion system for moving it to a new location or in predetermined patterns through use of a global positioning system and computer programs.

### BACKGROUND OF THE INVENTION

When the surface temperature of ocean water rises to near 80° F. hurricanes develop with great damage potential. Meteorologists monitor weather systems and conditions likely to develop into hurricanes and warnings are issued to those in the path of developing hurricanes. Never the less, lives are lost and catastrophic property damage is imparted by hurricanes.

### SUMMARY OF THE INVENTION

This invention provides marine water conversion apparatus and a method for reducing the surface temperature of a part of the ocean where the surface temperature has reached, or is close to reaching, a level that is conducive to the formation of hurricanes. Apparatus is provided to pump surface water several hundred feet below the ocean surface thereby creating a lava lamp effect body of warm water assisting cooler water below the removed surface water to rise to the surface. The apparatus is equipped with remotely controllable propulsion equipment for selectively positioning the apparatus geographically in the ocean through use of remote controls with a global positioning system. A computerized control system may include computer programs for moving the apparatus in a circular path or in a grid. The apparatus may also be used to alter current paths to clear harbors of accumulations of pollution. Use of the apparatus as described can cause nutrients at the bottom of the ocean to rise toward the surface, which is recognized as being beneficial to the fishing industry.

### DETAILED DESCRIPTION OF THE DRAWINGS

The invention is illustrated in the accompanying drawings, in which:

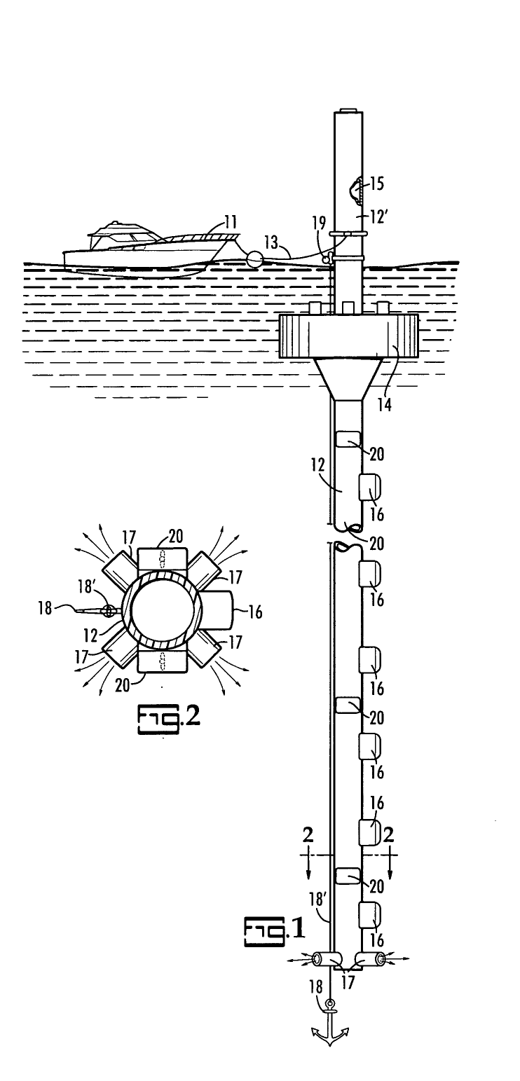

FIG. 1 is a side view of the apparatus employed to pump surface water to a predetermined ocean depth;

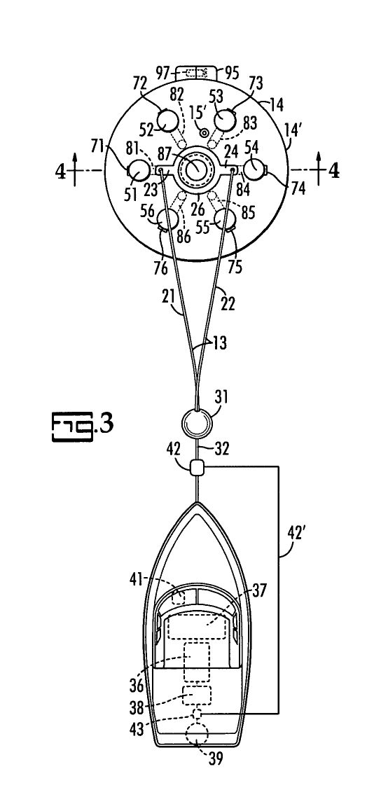

FIG. 2 is a section taken on line 2-2 in FIG. 1;

FIG. 3 is an enlarged top view of the apparatus shown in FIG. 1;

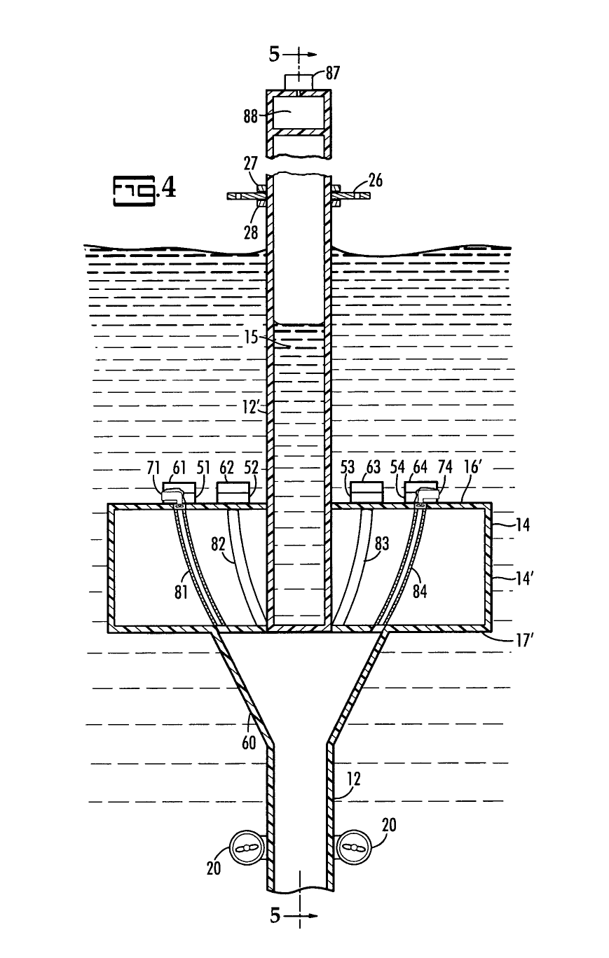

FIG. 4 is a section taken on line 4-4 in FIG. 3;

FIG. 5 is a section taken on line 5-5 in FIG. 4;

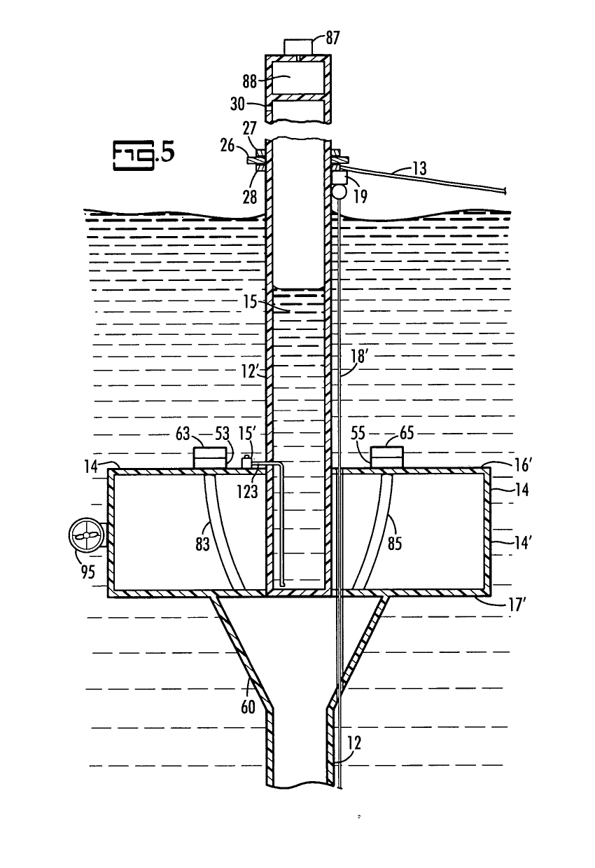

FIG. 6 is a vertical section showing an alternative propulsion feature and an alternate position for the power and control equipment;

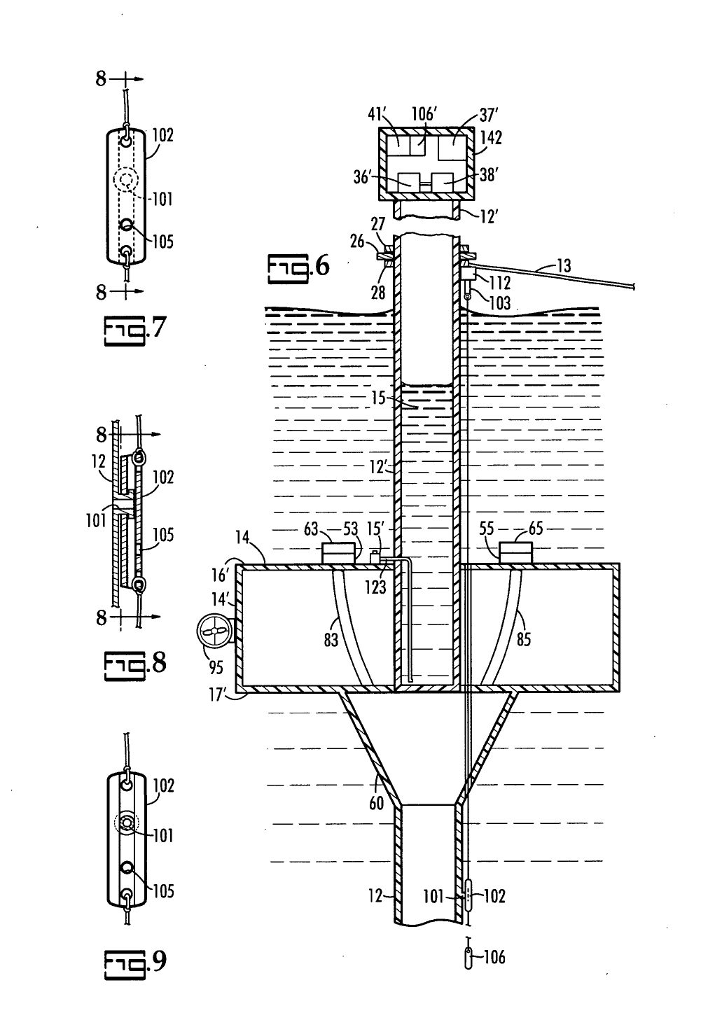

FIG. 7 is a section taken on line 7-7 in FIG. 6;

FIG. 8 is a section taken on line 8-8 in FIG. 7;

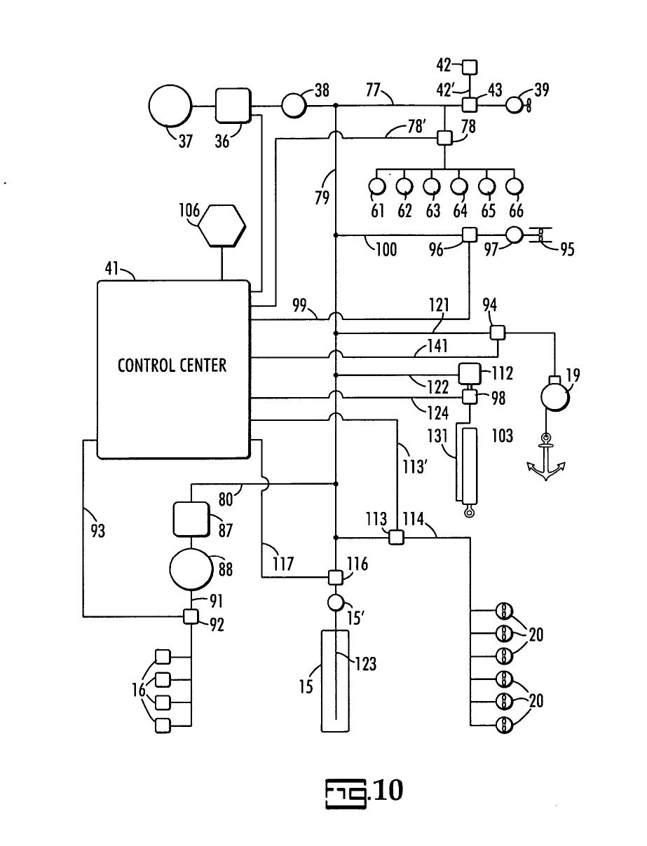

FIG. 9 is a section taken on line 9-9 in FIG. 8; and

FIG. 10 is a schematic showing of a control system for the apparatus used to cool the ocean surface.

### DETAILED DESCRIPTION OF THE INVENTION

FIG. 1 shows an apparatus for decreasing the temperature of ocean surface water. An equipment boat 11 is tethered by a painter 13 to an upper vertical pipe section 12′ extending upward from a cylindrical float tank 14, which has a cylindrical side wall 14′ and a flat top wall 16′. The tank 14 supports the pipe section 12′ and also supports a main vertical pipe 12 which may have a diameter of 8 to 10 feet and is several hundred feet long. The main pipe 12 and the pipe section 12′ need not be the same diameter. The pipe section 12′ is concentric with the cylindrical side wall 14′ of the tank 14 and extends downwardly through an opening in the top wall 16′ to the bottom wall 17′ of the tank 14, to which it is rigidly secured as by welding. The pipe section 12′ is aligned with the main pipe 12, is closed at the bottom of the tank 14 and is closed at its top by a compressed air chamber 88 thereby forming an air chamber 15 in the pipe section 12′. The amount of air in the air chamber 15 is controlled by a reversible electric motor driven water pump 15′ mounted on the tank 14 as shown in FIGS. 5 and 6. The pump 15′ moves water to and removes water from through a water conveying conduit 123. Air is admitted to the chamber 15 via an opening 30 in the pipe section 12′ just below the compressed air chamber 88. The depth of the tank 14 below the ocean surface can be adjusted by varying the volume of the air in the air chamber 15, such adjustment being made by operating a reversible electric motor driven pump 15′, which is mounted on the top wall 16′ of the tank 14 and is supplied electric power by a lead 79 as shown in FIG. 10.

A series of vertically spaced air chambers 16 are attached to one lateral side of the main pipe 12, which can be filled with air to aid in movement of the apparatus to a different location. Referring also to FIG. 2, four lateral discharge conduits 17 extend radially from the lower end of the main pipe 12 so as to discharge the surface water over a wide area to create a lava lamp effect. An anchor 18 for stabilizing the geographic position of the apparatus is suspended from the end of a cable 18′ controlled by an electrically powered cable winch 19 which is connected to an electric generator 38 by a lead 79 and a branch lead 121, as shown in FIG. 10. When it is desired to temporarily fix the position of the apparatus the anchor 18 may be lowered by the winch 19, which is controlled by a switch 94 in lead 121 operated by the control center 41 through lead 141. A series of electrically driven propulsion devices 20 with propellers are secured at regular vertical intervals to diametrically opposite sides of the pipe 16. The propulsion devices 20 are used to move the apparatus in a controlled manner as will hereinafter be explained in more detail.

Referring also to FIGS. 3, 4 and 5, the equipment boat 11 is tethered to the upstanding pipe section 12′ by the painter 13 which has a pair of lines 21, 22 having corresponding forward ends connected to arms 23, 24, respectively, extending radially outward in diametrically opposite directions from a pivot ring 26 pivotally supported on the pipe section 12′ between two axially spaced and radially outward extending parallel horizontal flanges 27, 28 secured to the pipe section 12′. The rearward ends of the lines 21, 22 are connected to a relatively small float 31 and the float 31 is connected to the equipment boat by a single line 32 of the painter 13. The equipment boat 11 carries an internal combustion engine 36, a fuel tank 37 for the engine 36, an electric generator 38 connected in driven relation to the engine 36, a propulsion unit in the form of a reversible electric motor 39 for propelling the boat 11 and a remotely controlled control center 41. A stress sensor unit 42 is provided in the line 32 and, when the stress in the line 32 reaches a first predetermined value, an electrical signal is sent to a switch 43 through lead 42′ to cause reversible electric drive motor 39 to be connected to the output of the generator 38 to automatically drive the boat 11 forward until the stress falls below a second predetermined value. This propulsion of the boat 11 relieves the floating main pipe 12 and the tank 14 of the drag otherwise imparted by the boat 11 in high wind conditions. In a calm weather condition excessive slack may develop in the painter 13, giving rise to danger of the painter 13 and the boat 11 becoming entangled with other components of the apparatus. In order to prevent possible entanglement, the stress sensor unit 42 sends an electrical signal to the switch 43 when a predetermined slack condition occurs, thereby causing the motor 39 to drive the boat in a reverse direction until the stress reaches a value indicative of absence of an excessively slack condition of the painter 13. Since the stress in the painter 13 fluctuates due to wave action, the stress sensor unit is provided with a computer program operating to average the sensed stress.

Six main pumps 51, 52, 53, 54, 55, 56 driven by electric motors 61, 62, 63, 64, 65, 66, respectively, are mounted on the top wall 16° of the tank 14 at 60 degree spacing in a circle concentric with the main pipe 12 and the tank 14. The six pumps 51, 52, 53, 54, 55, 56 are capable of drawing a high volume of surface, or near surface, water through their radially outward opening inlets 71, 72, 73, 74, 75, 76 and deliver the warm water to the main pipe 12 via conduits 81, 82, 83, 84, 85, 86 and a funnel portion 60 interconnected between the bottom wall 17′ of the tank 14 and the pipe 12. As shown in FIG. 10, the electric pump motors 61, 62, 63, 64, 65, 66 are connected to the generator 38 via an electric line 77 and an electric switch 78 controlled by the control center 41 via line 78′.

Referring also to FIG. 10, an electrically driven high pressure air compressor 87 is mounted on the compressed air chamber 88 at the upper end 12′ of the pipe 12 and is supplied electrical power through a line 79 and branch line 80. The compressed air storage chamber 88 is supplied compressed air by the compressor 87. Compressed air from the compressed air storage chamber 88 is delivered to the lower air chambers 16 via a conduit 91 and via a solenoid valve 92 controlled by the control center 41 via lead 93, the valve 92 having hold, exhaust and delivery positions of adjustment. Each air chamber 16 is equipped with an air operated valve, not shown, which allows water to escape when supplied pressurized air and allows water to return to the chamber 16 when pressurized air is not delivered to the chamber 16. When the air chambers 16 are filled with air, the pipe 16 will float in a horizontal position, thereby greatly facilitating its towed movement to a different position in the ocean.

An alternate pipe propulsion system is shown in FIGS. 6 through 9. A plurality of vertically spaced exhaust ports 101 are provided on the side of the pipe 12 opposite the side to which the air chambers 16 are secured. The ports 101 are opened and closed by vertical adjustment of the valve plates 102, such adjustment being provided by a single acting linear fluid actuator 103 connected to the valve plates 102 by an operating cable 104. The valve plates 102 are connected in series by short cable segments and a weight 106 is suspended from the bottom valve plate 102 to insure downward adjustment of the valve plates 102. When the plates 102 are adjusted upwardly by the actuator 103, a port 105 in the plate 102 is aligned with the associated opening 101 in the pipe 12, thereby allowing discharge of water from the pipe 12 through the openings 101. As shown in FIG. 10, the fluid actuator 103 is supplied pressure fluid via a valve 98 and a conduit 131 from an electrically powered fluid pressure supply system 112 including pressure tank, not shown, and an electric motor driven pump, not shown, which is connected to the generator 38 via a branch lead 122. The valve 98 is operated by the control center 41 through a control lead 124. FIG. 6 also shows an alternate location for power and control equipment including an engine 36′ driving an electric generator 38′, a fuel tank 37′, a control center 41′ and a global positioning system 106′ operatively mounted in a housing 142 secured to the upper end of the pipe section 12′. This alternate feature may eliminate the need for the equipment boat 11.

When it is desired to make an adjustment of the geographic position of the apparatus, the operator provides a global positioning system 106 with the new location data and the global positioning system 106 provides electronic instructions to the control center 41. The control center 41 through a control line 90 and a switch 96 in a branch lead 100 causes a reversible float turn motor 97 of a propulsion device 95 to orient the float tank 14 and pipe 12 in the selected direction. The control center 41, through lead 113′ also operates a switch 113 in electric line 114 to cause propelling operation of the propulsion units 20 thereby moving the apparatus to the selected location. If it is desired to move the apparatus a considerable distance the pipe 12 may be placed in a horizontal position by delivery of air to chambers 16 to move the pipe 12 to a horizontal position. The apparatus is then towed to a new location by the equipment boat 11 or other boat.

The float tank 14 and the upper pipe section 12′ are designed so that when a predetermined amount of water is pumped out of the air chamber 15 by the reversible electric motor driven pump 15′, effected by operation of a switch mechanism 116, in a lead 79, the top of the tank will rise above the level of the ocean, thereby facilitating service or replacement of the pumps 51-56, the motors 61-66, the pump 15′ and other equipment that may be mounted on the tank 14. As shown in FIG. 10, the reversible pump 15′ is connected to the generator by lead 79 via switch 116 which is connected to the control center 41 by a lead 117.

The herein disclosed marine water conversion apparatus is operable to change the water temperature of a significant ocean surface area. The radial discharge of the surface water from the circumferentially spaced discharge conduits 17 causes formation of a lava lamp area producing a lifting effect helping to replace the surface water being removed with cooler water directly beneath the removed surface water. The use of multiple units, properly positioned, can prevent development of a hurricane or greatly reduce its intensity. The use of remote controls to operate the control center avoids the need for stationing personnel on the conversion apparatus.

In addition to advantageously using the marine water conversion apparatus to alter or prevent hurricane development, as annularly occurs in the Caribbean sea, the apparatus can be used to counteract the El Nino warming of the ocean surface off the western coast of South America which occurs every 4 to 12 years, when the upwelling of cold nutrient-rich water does not occur. The water conversion apparatus can also be used to troll ocean currents to skew their path. This last mentioned use has application in cleaning harbors of debris. Use of the herein disclosed water conversion apparatus brings nutrient rich water toward the ocean surface thereby enhancing production to fish and other aquatic animals.

What is claimed is:

1. A marine water conversion apparatus, comprising:
a float tank having side, bottom and top walls,
a long vertical cylindrical main pipe suspended from said tank and having a lower end with a plurality of radially outward opening outlets,
an upstanding cylindrical pipe section secured to and extending upwardly extending from said float tank in coaxial relation to said main pipe terminating in a closed upper end to form an air chamber,
an air vent opening in said air chamber at the upper end of said pipe section,
a reversible water pump mounted on said tank,
a water conveying conduit interconnecting said reversible water pump and the lower end of said air chamber in said pipe section, and
a plurality of main water pumps mounted on said float tank and connected in water delivery relation to said main pipe, whereby operation of said main water pumps transfers surface water to said outlets at the lower end of said pipe,
said apparatus being positionable at a predetermined location in an ocean wherein said float tank is disposed below the ocean surface when air fills a first predetermined portion of said air chamber in said pipe section and wherein said top wall of said float tank is disposed above the ocean surface when water fills a second predetermined portion of said air chamber in said pipe section.

2. The apparatus of claim 1 having a series of vertically spaced propulsion devices on said main pipe operable to move said apparatus to a predetermined location in said ocean.

3. The apparatus of claim 2 wherein said propulsion devices include electrically driven propellers.

4. The apparatus of claim 2 wherein each of said propulsion devices includes a pair of electrically driven propellers on diametrically opposite sides of said pipe.

5. The apparatus of claim 1 having a plurality of vertically spaced air chambers secured to said pipe, a source of compressed air and control means for selectively delivering air to all of said chambers and for replacing said air with water in all of said chambers.

6. The apparatus of claim 1 having an equipment boat connected to said pipe section by a painter, a stress sensor in said painter, an electrically powered propulsion unit in said boat, a source of electricity in said boat, a control for connecting said propulsion unit to said source of electricity including a switch, said sensor being connected in signal delivery relation to said switch to cause said switch to connect said source of electricity to said propulsion unit to cause the boat to be propelled in a forward direction when the stress sensed by said sensor exceeds a maximum predetermined value.

7. The apparatus of claim 6 wherein said switch causes said source of electricity to be connected to said propulsion unit to cause said boat to be propelled in a rearward direction when the stress sensed by said sensor falls below a minimum predetermined value.

8. The apparatus of claim 1 having a propulsion device on a said side wall operable to rotate said float tank.

9. A marine water conversion apparatus, comprising:
a cylindrical float tank having a flat top wall, a cylindrical side wall and a bottom wall,
a relatively long main vertical cylindrical pipe having
a lower end with a plurality of radially outward opening outlets, and
a top end having an upward diverging conically shaped funnel rigidly secured at its top to said bottom wall of said tank in coaxial relation to said cylindrical side wall,
an annular opening in said top wall of said tank aligned with said main pipe,
an upstanding cylindrical pipe section extending upwardly extending through said annular opening in said top wall of said float tank and rigidly secured at its lower end to said bottom wall of said tank, said pipe section extending a substantial distance above said tank and terminating in a closed upper end to form an air chamber,
an opening in said upper end of said pipe section forming an air vent in said air chamber,
a reversible water pump mounted on said top wall of said tank,
a water conveying conduit interconnecting said reversible water pump and the lower end of said air chamber in said pipe section, and
a plurality of main water pumps mounted in circumferentially spaced relation to one another on said top wall of said float tank, said main water pumps having surface water intakes and being connected in water delivery relation to said funnel, whereby operation of said main water pumps transfers surface water to said outlets at the lower end of said pipe, when said apparatus is placed in an ocean,
said apparatus being positionable at a predetermined location in said ocean wherein said float tank is disposed below the ocean surface when air fills a first predetermined portion of said air chamber in said pipe section and wherein said top wall of said float tank is disposed above the ocean surface when water fills a second predetermined portion of said air chamber in said pipe section.

10. The apparatus of claim 9 having a series of vertically spaced propulsion devices on said main pipe operable to move said apparatus to a predetermined location in said ocean.

11. The apparatus of claim 10 wherein said propulsion devices include electrically driven propellers.

12. The apparatus of claim 10 wherein each of said propulsion devices includes a pair of electrically driven propellers on diametrically opposite sides of said pipe.

13. The apparatus of claim 10 wherein propulsion devices are a plurality of vertically spaced and vertically aligned openings from which water discharge is controlled by individual plate valves operated simultaneously.

14. The apparatus of claim 9 having a plurality of vertically spaced air chambers secured to said pipe, a source of compressed air and control means for delivering air to all of said chambers and for replacing said air with water in all of said chambers.

15. The apparatus of claim 9 having an equipment boat connected to said pipe section by a painter, a stress sensor in said painter, an electrically powered propulsion unit in said boat, a source of electricity in said boat, a control for connecting said propulsion unit to said source of electricity including a switch, said sensor being connected in signal delivery relation to said switch to cause said switch to connect said source of electricity to said propulsion unit to cause the boat to be propelled in a forward direction when the stress sensed by said sensor exceeds a maximum predetermined value.

16. The apparatus of claim 15 wherein said switch causes said source of electricity to be connected to said propulsion unit to cause said boat to be propelled in a rearward direction when the stress sensed by said sensor falls below a minimum predetermined value.

17. The apparatus of claim 9 having a propulsion device on said float tank operable to rotate said float tank.

18. A marine water conversion apparatus for pumping surface water of the ocean several hundred feet beneath the ocean surface, comprising:
a float tank having top, bottom and side walls,
a long main vertical pipe having
an upper end rigidly secured to said bottom wall and
a lower end with a plurality of radially outward opening outlets,
an upstanding pipe section having a lower end rigidly secured to said tank, said upstanding pipe section having closed upper and lower ends to form an air chamber and an air vent for said air chamber near the upper end of said pipe section,
a reversible water pump supported by said tank,
a water conveying conduit interconnecting said reversible water pump and said air chamber,
a plurality of main water pumps mounted on said tank having ocean surface water intakes and being connected in water delivery relation to,
said upper end of said main vertical pipe,
propulsion equipment operable to propel said apparatus in said ocean, and
a remote control system for said pumps and said propulsion equipment including a global positioning system operable to move said apparatus to selected locations in said ocean.

19. The apparatus of claim 18 wherein said float tank is disposed below the ocean surface when at least a first predetermined portion said air chamber of said pipe section is filled with water and wherein said float tank is disposed at the surface of said ocean when at least a second predetermined portion of said air chamber of said pipe section is filled with air.

20. The apparatus of claim 18 having computer programs in said remote control system for causing said apparatus to move in predetermined grid patterns.

21. The apparatus of claim 18 having computer programs in said remote control system for causing said apparatus to move in predetermined circular patterns.

22. The apparatus of claim 18 including a generator, an engine drivingly connected to said engine, a control center and a global positioning system operatively positioned in a housing secured to the upper end of said pipe section.
